(19) United States
(12) Patent Application Publication
(10) Pub. No.: US 2026/0056422 A1
(43) Pub. Date: Feb. 26, 2026

(54) PROTECTIVE DEVICES FOR EYEGLASS NOSE PADS

(71) Applicant: Kimberly CAVALIER, Ebensburg, PA (US)

(72) Inventor: Kimberly CAVALIER, Ebensburg, PA (US)

(21) Appl. No.: 18/812,492

(22) Filed: Aug. 22, 2024

(51) Int. Cl. G02C 5/12

(52) U.S. Cl. CPC G02C 5/122

(57) ABSTRACT

A protective device for the nose pads and pad support arms on eyeglasses. The device fits over or replaces the nose pads on eyeglasses and provides a smooth transition surface between the nose pad and the frame of the eyeglasses. The device includes a polymeric body having an inner cavity and at least one opening. The opening is designed to rest against a rim of the eyeglasses when the device is installed over the nose pad and pad support arm, and the polymeric body is designed to accept the nose pad and pad support arm therein and fit snugly about at least the nose pad.

### FIELD OF INVENTION

This disclosure generally relates to covers for the nose pads and nose pad supports on eyeglasses, and more specifically to devices that fit over or replace the nose pads on eyeglasses to provide a smooth transition surface between the nose pad and the frame of the eyeglasses.

### BACKGROUND

Eyeglasses with nose pads attached via wire supports have been a staple in optical design for decades, offering adjustability and comfort (see pads 5 and supports 6 in FIG. 1A). However, despite their widespread use, they are not without issues. A common problem is the difficulty in adjusting these types of nose pads. The wire support can be delicate and prone to bending out of shape, which makes it challenging to achieve a customized fit that evenly distributes the weight of the glasses. This uneven distribution can contribute to discomfort and may cause the glasses to slip down the wearer's nose. Durability is also a concern with wire-supported nose pads. The wire itself may weaken over time, particularly with frequent adjustments or rough handling. This can lead to a loss of shape or even breakage, necessitating repairs or replacement of the entire frame. Hygiene is another issue that arises with wire-supported nose pads. The area where the wire contacts the skin can accumulate dirt, oil, and sweat, which not only affects comfort but also requires regular cleaning to maintain hygiene. Additionally, there is also the well-known problem of wire-supported nose pads getting caught in the wearer's hair. The thin wire can easily entangle strands of hair when the wearer pushes the glasses up on their head, causing discomfort and potentially leading to hair breakage when the glasses are removed (see FIG. 1B). Overall, while wire-supported nose pads offer adjustability and functionality, they come with a range of drawbacks that impact comfort, durability, and hygiene for eyeglass wearers.

German Patent 102009047372 offers a possible solution to certain of these issues by providing a protective device that covers the region between the mountings for the nose pad support arms at the frame of the glasses and the nose pads. However, a gap remains between the device and the nose pads that may continue to entangle the wearer's hair, and the nose pads and regions around the nose pads may continue to accumulate dirt, oil, and sweat.

Accordingly, devices that may provide a smooth transition surface between the nose pad and the frame of the eyeglasses are desired.

### SUMMARY

The systems and methods of the present disclosure solve many of the aforementioned problems by providing protective devices for the pad support arms on eyeglasses that offer a smooth transition surface between the nose pad and the frame of the eyeglasses. In certain configurations the devices may cover both the nose pad and pad support arm and conform snugly to the shape of the nose pad. In other configurations, the devices may be designed as a sleeve and may cover the pad support arm and only a portion of the nose pad. In yet other configurations, the device may provide a replacement for the nose pad and a cover for the pad support arm. In any configuration, the device may include a longitudinal opening and opposite hinge region such that the device may be closed or snapped over the pad support arm and optionally also the nose pad.

Thus, according to its major aspects, and briefly stated, the present disclosure relates to a protective device for nose pads and pad support arms on eyeglasses. The device comprises a main body having an inner cavity and an opening. When installed on a pair of eyeglasses, the opening is configured to rest against a rim of the eyeglasses and the main body is configured to accept the pad support arm and at least a portion of the nose pad therein and fit snugly about at least the nose pad.

In certain embodiments, the main body is formed of a polymeric material (“polymeric body”). In certain embodiments, the polymeric body is formed of a pliable polymeric material. In certain embodiments, the polymeric body is formed of a stretchable polymeric material such as an elastomer.

In certain embodiments, the inner cavity of the polymeric body is configured to have a shape that is complementary to the shape of the nose pad and the pad support arm.

In certain embodiments, the polymeric body and the opening generally comprise a pliable or stretchable material providing the device with at least two shapes, including: (i) an uninstalled shape in which the device is separated from the nose pad and pad support arm, wherein the opening has a first overall dimension, and the polymeric body is unstretched, and (ii) an installed shape in which the device is positioned around the nose pad and pad support arm so that the polymeric body is stretched thereabout to conform to a shape of the nose pad, and the opening has a second overall dimension substantially the same as the first overall dimension.

In certain embodiments, the polymeric body includes a second opening opposite the opening so that the device is configured as a sleeve, wherein when the device is positioned around the nose pad and pad support arm, the second opening is stretched around at least a portion of the nose pad. In this embodiment, the polymeric body, the opening, and the second opening generally comprise a pliable or stretchable material providing the device with at least two shapes, including: (i) an uninstalled shape in which the device is separated from the nose pad and pad support arm, wherein the opening has a first overall dimension, and the polymeric body and second opening are unstretched, and (ii) an installed shape in which the device is positioned around at least a portion of the nose pad and all of the pad support arm so that the polymeric body and second opening are stretched thereabout to conform to a shape of the portion of the nose pad that is covered, and the opening has a second overall dimension substantially the same as the first overall dimension.

In certain embodiments, the polymeric body further comprises a ridge on an inner surface thereof, wherein the ridge is configured to interact with the pad support arm to secure the device thereon.

In certain embodiments, the opening comprises a thickened region of the polymeric body, i.e., a region having a thickness that is greater than a thickness of the polymeric body.

In certain embodiments, the polymeric body comprises a thickened region on an inner surface thereof that is distal from the opening, wherein the thickened region is configured to interact with the pad support arm to secure the device thereon, e.g., the thickened region may be configured as a protrusion. The thickened region may be designed and configured as a nose pad and may include a protrusion configured to provide attachment of the thickened region to the pad support arm of the eyeglasses.

The present disclosure relates to a protective device for nose pad support arms on eyeglasses. The device may comprise a polymeric body having an inner cavity with first and second openings, wherein the inner cavity comprises a thickened region shaped as a nose pad and including a protrusion configured for attachment to the nose pad support arm of the eyeglasses, wherein the first opening is distal from the thickened region and is configured to rest against a rim of the eyeglasses when the device is installed over the nose pad support arm, and wherein the second opening is adjacent an outer edge of the thickened region and, when the device is installed over the nose pad support arm, the second opening is configured to provide access to the nose pad support arm and allow connection of the protrusion thereto.

In certain embodiments of the protective device for nose pad support arms, the device is formed of a pliable or stretchable material and has at least two configurations comprising: (i) an initial configuration in which the device is separated from the nose pad support arm, wherein the opening has a first overall dimension, and the polymeric body is unstretched, and (ii) an installed configuration in which the device is attached to the eyeglasses via connection with the nose pad support arm, wherein the polymeric body is stretched and the first opening has a second overall dimension substantially the same as the first overall dimension.

In certain embodiments of the protective device for nose pad support arms, the first opening may comprise a thickened region of the polymeric body, i.e., a region having a thickness that is greater than a thickness of the polymeric body.

In any of the aforementioned embodiments, the polymeric material may comprise an elastomer.

In any of the aforementioned embodiments, the polymeric body may include a longitudinal opening and a hinge region opposite the longitudinal opening, such that the device has an open configuration wherein respective edges of the polymeric body along the longitudinal opening are not in contact with each other and a closed configuration wherein the respective edges of the polymeric body along the longitudinal opening are in contact with each other.

In any of the aforementioned embodiments comprising the longitudinal opening, the polymeric body may comprise a pliable material providing the device with at least two shapes, including: (i) an uninstalled shape in which the device is separated from the nose pad and nose pad support arm, wherein the polymeric body is unstretched in either the open or closed configuration, and (ii) an installed shape in which the device is positioned around the nose pad and nose pad support arm and in the closed configuration such that the polymeric body is stretched around and conforms to a shape of the nose pad.

In any of the aforementioned embodiments comprising the longitudinal opening, the respective edges of the polymeric body along the longitudinal opening include closure elements.

### DESCRIPTION OF THE DRAWINGS

Aspects, features, benefits, and advantages of the embodiments disclosed herein will be apparent with regard to the following description, appended claims, and accompanying drawings. In the following figures, like numerals represent like features in the various views. It is to be noted that features and components in these drawings, illustrating the views of embodiments of the present disclosure, unless stated to be otherwise, are not necessarily drawn to scale. The devices and methods disclosed herein may be better understood by reference to the accompanying drawing sheets, in which:

FIGS. 1A and 1B illustrate prior art eyeglasses having nose pads attached via wire supports.

FIG. 2 illustrates a protective device for the nose pads and wire supports of eyeglasses according to aspects of the present disclosure installed over the nose pad and wire support of a pair of standard eyeglasses.

FIG. 3 illustrates the protective device of FIG. 2.

FIG. 4 illustrates another protective device for the nose pads and wire supports of eyeglasses according to aspects of the present disclosure installed over the nose pad and wire support of a pair of standard eyeglasses.

FIG. 5 illustrates the protective device of FIG. 4.

FIG. 6 illustrates another protective device for the nose pads and wire supports of eyeglasses according to aspects of the present disclosure installed over the nose pad and wire support of a pair of standard eyeglasses.

FIG. 7 illustrates the protective device of FIG. 6.

FIG. 8 illustrates another protective device for the nose pads and wire supports of eyeglasses according to aspects of the present disclosure installed over the nose pad and wire support of a pair of standard eyeglasses.

FIG. 9A illustrates the protective device of FIG. 8.

FIG. 9B illustrates an enlarged cross-sectional view of a ridge on an inside of the protective device of FIG. 9A useful to secure the device to the eyeglasses.

FIG. 10 illustrates another protective device for the nose pads and wire supports of eyeglasses according to aspects of the present disclosure in a closed configuration.

FIG. 11 illustrates the protective device of FIG. 10 in an open configuration.

### DETAILED DESCRIPTION

In the following description, the present invention is set forth in the context of various alternative embodiments and implementations of a protective device for the nose pads and pad support arms on eyeglasses. The protective device fits snugly over the nose pad and pad support arm to provide a smooth transition surface between the rim of the glasses and the nose pad. As such, the device acts to reduce the accumulation of dirt in crevices of the nose pad and support arms, reduce the risk for damage to the pad support arms, and decrease the chance that the wearer's hair will become entangled with the glasses when they push them up onto their head.

### Definitions and Abbreviations

Various aspects of the devices and methods of use thereof disclosed herein may be illustrated by describing components that are coupled, attached, and/or joined together. As used herein, the terms “coupled,” “attached,” and/or “joined” are interchangeably used to indicate either a direct connection between two components or, where appropriate, an indirect connection to one another through intervening or intermediate components. In contrast, when a component is referred to as being “directly coupled,” “directly attached,” and/or “directly joined” to another component, there are no intervening elements shown in said examples.

Various aspects of the devices and methods of use thereof disclosed herein may be illustrated with reference to one or more exemplary implementations. As used herein, the term “exemplary” means “serving as an example, instance, or illustration,” and should not necessarily be construed as preferred or advantageous over other variations of the systems, devices, and methods disclosed herein. “Optional” or “optionally” means that the subsequently described component, event, or circumstance may or may not be included or occur, and the description encompasses instances where the component or event is included and instances where it is not.

Furthermore, throughout the specification, reference to “one embodiment,” “an embodiment,” or “some embodiments” means that a particular described feature, structure, or characteristic is included in at least one embodiment. Thus, appearances of the phrases “in one embodiment,” “in an embodiment,” or “in some embodiments” in various places throughout this specification are not necessarily all referring to the same embodiment. Those skilled in the art will recognize that the various embodiments can be practiced without one or more of the specific details or with other methods, components, materials, etc. In other instances, well-known structures, materials, or operations are not shown or not described in detail to avoid obscuring aspects of the embodiments.

Certain terminology is used in the following description for convenience only and is not limiting. The words “lower,” “upper,” “bottom,” “top,” “front,” “back,” “left,” “right” and “sides” designate directions in the drawings to which reference is made but are not limiting with respect to the orientation in which the various parts of the systems and devices disclosed herein may be used unless otherwise indicated.

It must also be noted that as used herein and in the appended claims, the singular forms “a,” “an,” and “the” include the plural reference unless the context clearly dictates otherwise. For example, “an” opening may refer to one or more openings unless indicated otherwise. Unless defined otherwise, all technical and scientific terms used herein have the same meanings as commonly understood by one of ordinary skill in the art.

“Substantially the same,” as used herein, is understood to mean that two values or measurements are within 30% of each other, such as within 20% of each other, or within 10% of each other, or even within 5% of each other. Where it is indicated that two values are the same as each other is understood to mean that two values or measurements deviate from one another by less than 5%, or even less than 2%.

The term “dimension,” as used herein, should be understood to include any of a length, a width, a height, a diameter, a radius, a circumference, and the like.

All numerical quantities stated herein are approximate, unless indicated otherwise, and are to be understood as being prefaced and modified in all instances by the term “about.” The numerical quantities disclosed herein are to be understood as not being strictly limited to the exact numerical values recited. Instead, unless indicated otherwise, each numerical value included in this disclosure is intended to mean both the recited value and a functionally equivalent range surrounding that value.

All numerical ranges recited herein include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10.

As generally used herein, the terms “include,” “includes,” and “including” are meant to be non-limiting. As generally used herein, the terms “have,” “has,” and “having” are meant to be non-limiting.

### Aspects and Embodiments of the Present Disclosure

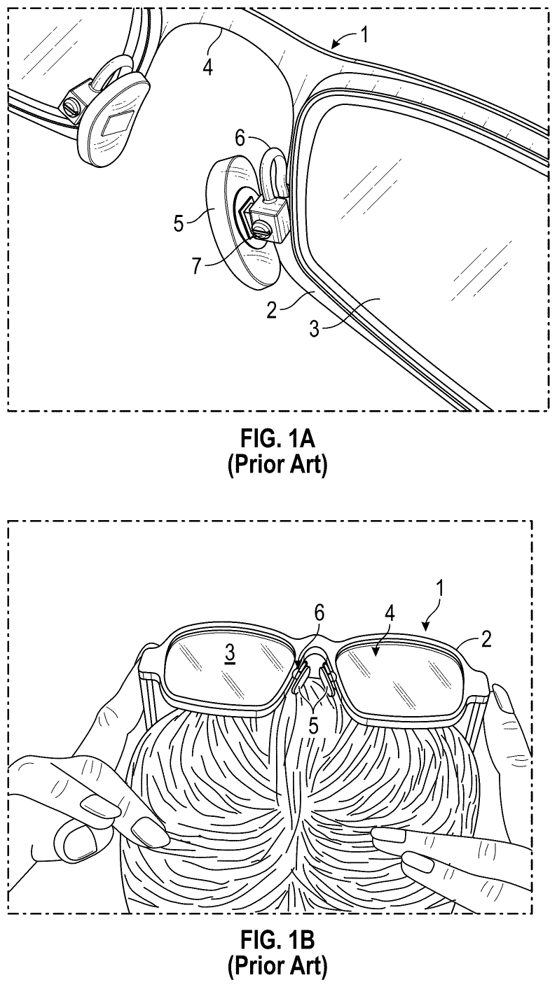

With reference to the figures, the devices disclosed herein are designed and configured to cover and/or replace the nose pad and further cover the pad support arms on a pair of glasses, such as prescription glasses, sunglasses, sport glasses, safety glasses, and the like (“eyeglasses”). With reference to FIGS. 1A and 1B, standard eyeglasses 1 include a frame 2 that supports lenses 3. In the majority of eyeglass designs, the frame includes a bridge region 4 between the two lenses. Positioned on the frame 2 adjacent the bridge region 4, i.e., in a region of the glasses configured to make contact with a wearer's nose, many eyeglasses include pads 5 designed to make contact with the wearer's nose. These pads 5, i.e., nose pads, are supported on the frame of the glasses via a pad support arm 6. In general, the nose pads 5 are removeably attached to the pad support arm 6 via a small screw 7.

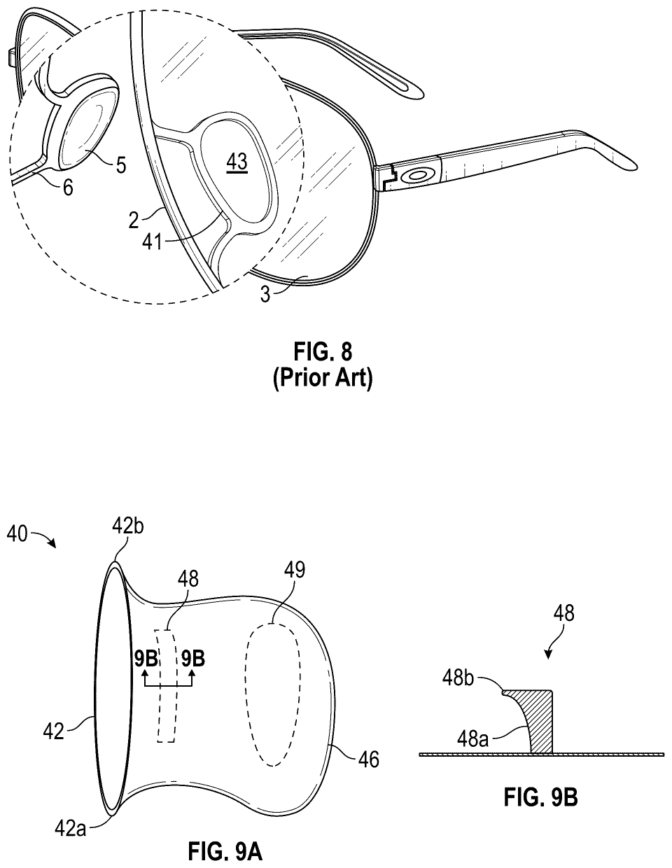

In some eyeglass designs, the pad support arms 6 include an opening configured to accept the nose pads 5 therethrough. For example, as shown in FIG. 8, the nose pad may include an indented region about an outer circumference thereof. When the pad 5 is pushed onto the opening in the pad support arm 6, a surface of the indented region of the pad 5 catches an inner surface of the opening and secures the pad 5 thereon.

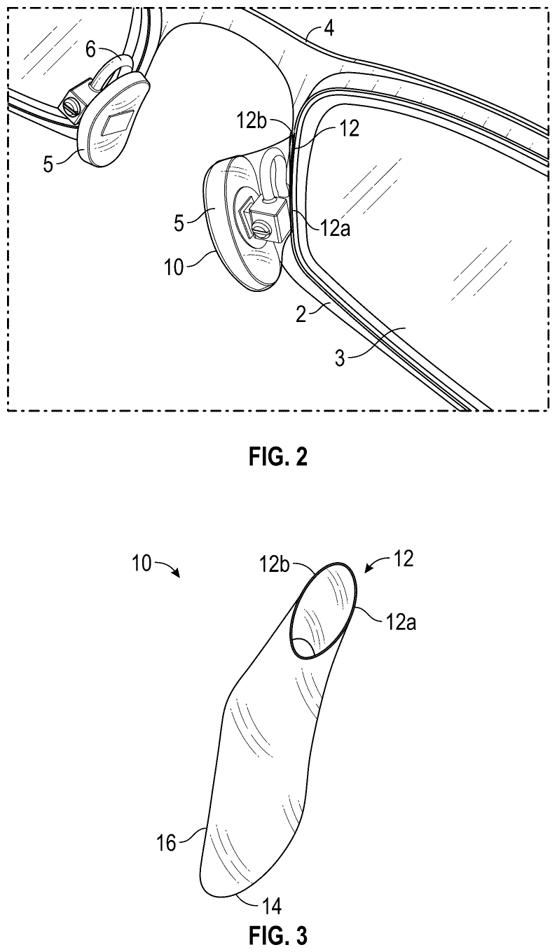

In both cases, the eyeglasses of FIGS. 1A and 8 have areas that can accumulate dirt, oil, and sweat, which not only affects comfort but also requires regular cleaning to maintain hygiene. Moreover, the wire supports for the nose pads of the eyeglasses of FIG. 1A may become entangled in a wearer's hair should they push the eyeglasses up on their head, such as is common for wearers of sunglasses as shown in FIG. 1B. The devices of the present disclosure offer a solution by providing a polymeric body configured to fit over or replace the nose pad and cover the pad support arm. As such, the device provides a smooth transition surface between the rim of the glasses and the nose pad that is easy to clean, protects the wire supports, and does not become entangled in a wearer's hair. Various embodiments of the device are shown in FIGS. 2-11.

With specific reference to FIGS. 2 and 3, a protective device designed to cover both the nose pad and pad support arm is shown. The device 10 generally includes a polymeric body having an inner cavity and an opening 12. The device 10 may be installed on eyeglasses by pushing and/or pulling the opening 12 over the nose pad 5 and pad support arm 6 until the opening 12 rests against a frame 2 of the eyeglasses. As shown in FIG. 2, the opening rests snugly against the frame 2 of the eyeglasses in a region adjacent the bridge 4 region.

The device 10 may be configured such that the polymeric body is highly stretchable and when installed over the nose pad 5 and pad support arm 6, the polymeric body stretches to conform to a shape of the nose pad 5. As such, a size of the polymeric body before installation on the eyeglasses may be smaller than the nose pad 5 and may not necessarily have a shape coincident with the nose pad 5 (i.e., may have any shape, such as a spherical, oblong, etc., much as a “cover” with an internal cavity). Thus, the polymeric body may have an uninstalled shape in which the device is separated from the nose pad 5 and pad support arm 6, wherein the polymeric body is unstretched, and an installed shape in which the device is positioned around the nose pad and pad support arm so that the polymeric body is stretched thereabout to conform to a shape of the nose pad.

In certain embodiments, the region of the polymeric device configured to surround the pad support arm 6 may be designed to have an inner dimension large enough to accept the pad support arm 6 with little to no stretch. As such, the device may be designed so that the polymeric body does not substantially conform to a shape of the pad support arm 6, i.e., forms a smooth transition surface between the nose pad and the frame 2 of the glasses.

The opening 12 of the device 10 may have an uninstalled shape having a first overall dimension when the device is separated from the nose pad 5 and pad support arm 6, and an installed shape having a second overall dimension when the device is positioned around the nose pad 5 and pad support arm 6. The first overall dimension may be substantially the same as, or the same as, the first overall dimension. Further, in some embodiments, the shape of the opening 12 may be substantially the same, or the same, when installed and uninstalled.

In some embodiments, the opening 12 may include a thickened region or rim designed to make contact with the frame 2. The thickened region may provide additional support for the opening 12 such that the uninstalled and installed shape of the opening are substantially the same or are the same.

In some embodiments, the polymeric body may have a shape coincident with the shape of the nose pad 5 and pad support arm 6. For example, the polymeric body of the device 10 may include an end 14 that is distal from the opening 12 and a flattened region 16 therebetween. The flattened region 16 may be shaped as the region of a nose pad 5 that is configured to rest against a wearer's nose. While having a shape coincident with certain regions of the nose pad, the polymeric body may still stretch to conform to an overall shape of the nose pad 5, i.e., have an initial uninstalled size slightly smaller than the size of the nose pad 5. When configured as such, the opening 12 may have a specific orientation when the device is installed over the nose pad 5 and pad support arm 6, such that a top 12b of the opening 12 may rest against the frame closer to the bridge 4 while a bottom 12a of the opening may rest against the frame more distal from the bridge 4.

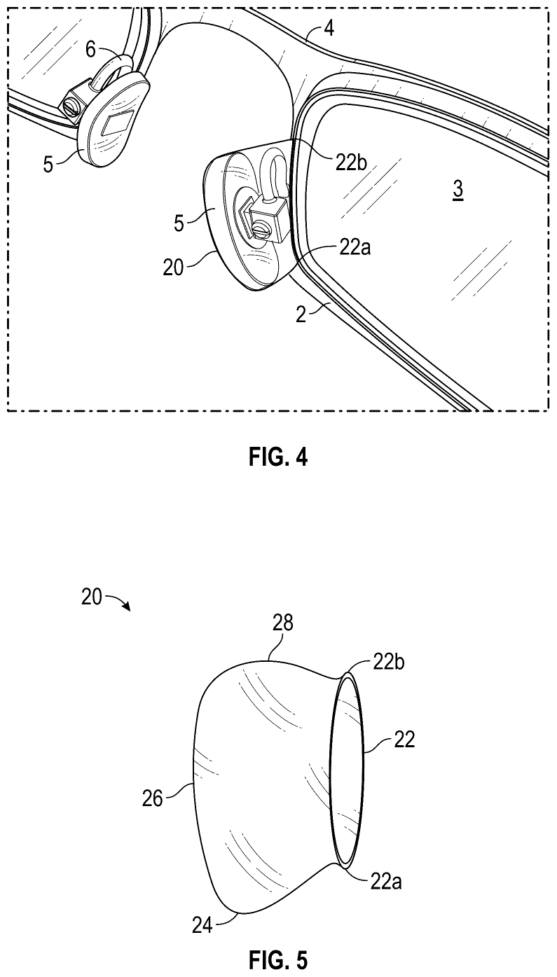

With reference to FIGS. 4 and 5, the device 20 may have a polymeric body with an opening 22 and a opposite distal edge 26. As with the device shown in FIGS. 2 and 3, the polymeric body may be pushed and/or pulled over the nose pad 5 so that the opening contacts the rim of the eyeglasses. In some embodiments, the device 20 may be formed of a pliable polymeric material that is stretchable. As such, the size of the polymeric body may be slightly smaller than a dimension of the nose pad such that the polymeric body stretches over the nose pad and conforms to a shape thereof. However, as shown in FIG. 4, the regions of the polymeric body adjacent to the pad support arm 6, when installed thereon, may be configured to not make contact with the pad support arm. The polymeric body continues to form smooth transition surface between the nose pad and the frame 2 of the glasses.

In some configurations, the end 26 may have a shape substantially coincident with a shape of the nose pad 5 while a remainder of the polymeric body may have a shape that is substantially flattened, such as an oblate spheroid (e.g., spheroid with a longer major axis and a shorter minor axis). That is, the top, bottom, and distal end (28, 24, 26, respectively) of the polymeric body may form a rim about the major axis. When configured as such, the opening 22 may have a specific orientation when the device is installed over the nose pad 5 and pad support arm 6 such that a top 22b of the opening 22 rests against the frame closer to the bridge 4 while a bottom 22a of the opening rests against the frame more distal from the bridge 4.

In some configurations, the device 20 may be formed of a stretchable polymeric material and may have a thickness such that the device is not stretched to fit over the nose pad and pad support arm but is sized and shaped to fit over a specific configuration of nose pad and pad support arm (i.e., thicker polymeric material that is not stretched over those elements). In some configurations, the device 20 may be formed of a pliable polymeric material that is substantially non-stretchable, or of a non-pliable polymeric material. As such, the polymeric body may be pushed onto the nose pad and pad support arm so that the opening 22 contacts the rim of the eyeglasses. In this latter configuration, the device may include inner elements, e.g., ridges, hooks, adhesive, which interact with portions of the nose pad or pad support arm to secure the device 20 thereon. Alternatively, or additionally, the device may include adhesive or other elements on the opening (e.g., opening 22) positioned to interact with the rim of the eyeglasses to secure the device thereto. For example, the opening 22 may include small sections of adhesive at a top and bottom of the opening (22a, 22b), on sides of the opening, or along the entire circumference of the opening.

In some configurations, the device 20 may have an internal shape configured to conform to a shape of at least the nose pad, or the nose pad and pad support arm (e.g., pliable or malleable material). Moreover, the device 20 may have an external shape configured to mimic the shape of a nose pad 5, or at least the regions of a nose pad 5 configured to contact the nose of the wearer. A remainder of the polymeric body that would surround the pad support arm may not have a shape coincident with the pad support arm 6.

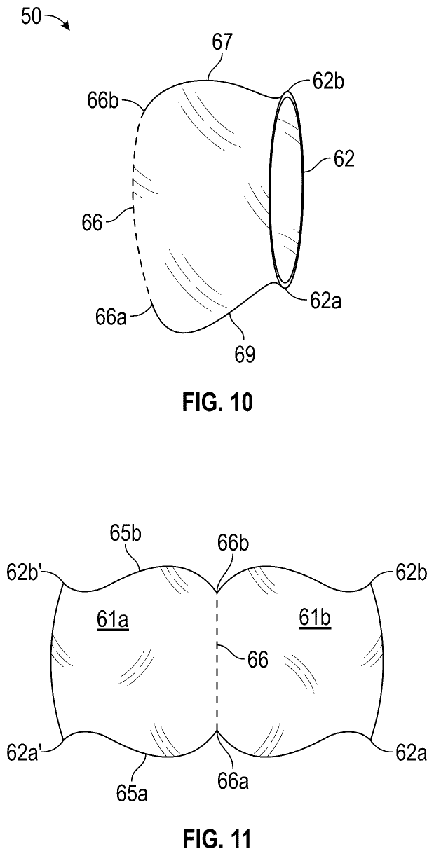

With continued reference to FIGS. 2 through 5, the device may include a second opening (see for example FIG. 10, wherein the second opening may lie along the dotted line 66) that is distal from the opening (12, 22) such that the polymeric body is configured as a sleeve. In this arrangement, the device may be formed of a pliable or stretchable material and may be installed on the eyeglasses by pushing and/or pulling the opening (12, 22) onto the nose pad 5 and over the pad support arm 6 so that the opening (12, 22) rests against the frame 2 of the eyeglasses. The polymeric body may at least partially encase the nose pad 5 such that the second opening is stretched to fit around the nose pad 5.

With reference to FIGS. 8 and 9, the device 40 may include a polymeric body having an opening 42 and an opposite closed distal end 46. The device 40 may include one or more ridges on an inner surface of the polymeric body. For example, the device may include a ridge 48 that is sized and shaped to interact with the pad support arm 6, such as interacting with an inner spoke 41 of the pad support arm 6. The ridge 48 may include a recessed region 48a and a ledge 48b, wherein the ledge 48b may hook over the spoke 41 and secure the device 40 to the pad support arm 6 (see FIG. 9B).

The device may include a protrusion 49 or thickened region that is sized and configured to interact with the pad support arm 6, such as interacting with an opening 43 in the pad support arm 6. In some embodiments, the protrusion 49 may be designed and configured as a nose pad. In such a configuration, the protrusion 49 may comprise a thicker region on the inside surface of the polymeric body that may not stretch to the same extent as the remainder of the polymeric body or may not stretch at all. When formed as a nose pad, the protrusion 49 may reside on a side of the polymeric body configured to contact the nose of the wearer. As such, a set of devices designed for a pair of eyeglasses may include the protrusion 49 on one inner side of the polymeric body for one device and the opposite inner side of the polymeric body for the second device.

The protrusion 49 may include a recessed region about a circumferential edge thereof. When the protrusion 49 is pushed through the opening 43, the edges of the opening 43 interact with the recessed region of the protrusion 49 to secure the protrusion to the opening 43 and thus the device 40 over the nose pad and pad support arm.

In each of the embodiments shown in FIG. 2-5 and 8-9, the device may be formed as two halves closeable over the nose pad and pad support device. That is, the polymeric body (10, 20, 40) may include a longitudinal opening and a hinge region opposite the longitudinal opening. When designed as such, i.e., device includes a longitudinal opening and an opposite hinge region, the material of the polymeric body may be pliable and stretchable. Alternatively, in certain embodiments, the polymeric body may be pliable and substantially non-stretchable. When stretchable, closure elements for the two halves may include regions on each halve that are substantially non-stretchable so that the two halves may be securely connected or closed. The closure elements may be designed to provide secure closure along a substantial length of the longitudinal opening. Exemplary closure elements include at least protruding hooks on one edge of the longitudinal opening and complementary recessed regions that provide connection for the hooks on the opposite edge of the longitudinal opening.

As example, and with reference to FIG. 10, the device 50 may have a first opening 62, a longitudinal opening (67, 69), and a hinge region 66 opposite the longitudinal opening. The device may have an open configuration (see FIG. 11) wherein respective edges (65a, 65b, 65a′, 65b′) of the polymeric body along the longitudinal opening (67, 69) are not in contact with each other and a closed configuration (see FIG. 10) wherein the respective edges of the polymeric body along the longitudinal opening (67, 69) are in contact with each other.

In some embodiments, the polymeric body of the device 50 generally comprises a pliable or stretchable material providing the device with at least two shapes. That is, the device 50 may have an uninstalled shape in which the device is separated from the nose pad 5 and nose pad support arm 6, wherein the polymeric body is unstretched in either the open or closed configuration, and an installed shape in which the device 50 is positioned around the nose pad and pad support arm and in the closed configuration such that the polymeric body is stretched around and conforms to a shape of the nose pad. When the device includes one or more protrusions, such as shown in FIG. 9A, these protrusions may be connected to their respective portions of the pad support arm when the device is in the open configuration.

Alternatively, the polymeric body of the device 50 comprises a pliable but substantially non-stretchable material. As such, the device in both the open and closed configurations has substantially the same size and shape (i.e., remains unstretched such that the installed shape and the uninstalled shape are substantially the same or are the same). The polymeric body of the device 50 may alternatively comprise a non-pliable polymeric material.

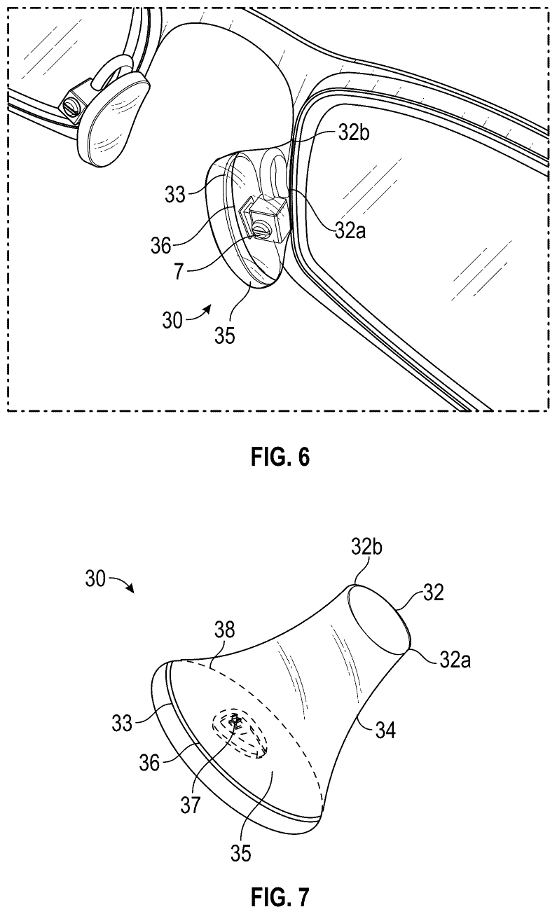

In certain embodiments, and with reference to FIGS. 6 and 7, the device 30 may include a polymeric body having an inner cavity with first and second openings. The inner cavity may comprise a thickened region 35 shaped as a nose pad and including a protrusion 37 configured for attachment to the pad support arm of the eyeglasses. For example, the protrusion 37 may include a bore configured to provide passage of a small screw 7 that provides connection between an end of the pad support arm and the protrusion 37. Such connection is standard in the field and a well-known means for connecting a nose pad 5 to a pad support arm 6. Because the thickened region 35 of the device 30 is formed as a nose pad, it generally comprises a thicker region on the polymeric body that may not stretch to the same extent as the remainder of the polymeric body, or the thickened region 35 may not stretch at all.

The first opening 32 is typically distal from the thickened region 35 and is configured to rest against a rim of the eyeglasses when the device is installed over the pad support arm. The second opening 36 is adjacent an outer edge 33 of the thickened region and, when the device is installed over the pad support arm, the second opening 36 is configured to stretch to an open position to provide access to the pad support arm and allow connection of the protrusion 37 thereto, e.g., allow a user to connect the thickened region 35 to the end of the pad support arm by passing a small screw 7 through a bore in the end of the pad support arm and the bore in the protrusion 37.

The device 30 is generally formed of a pliable or stretchable material. As such, the device may have at least two configurations, including an uninstalled configuration and an installed configuration. In general, the polymeric body, including the first and second openings, may remain unstretched in the uninstalled and installed configurations. During installation, however, the first opening 32 may stretch to fit over the pad support arm and the second opening may be stretched during attachment of the protrusion 37 of the thickened region 35 to the end of the pad support arm (e.g., as described above, via a small screw).

In embodiments of the device (10, 20, 30, 40, 50), a majority of the device may be formed of a pliable or stretchable polymeric material, such as stretchy rubber or an elastomeric material. As used herein a “pliable” or “stretchable” material should be understood to mean a material that can be expanded in at least in one direction, without breaking and regains its original dimensions after release of tension. In one embodiment, the stretchable material conforms to the shape of at least the nose pad.

Suitable stretchable materials include polymers such as elastomeric polymers. Examples of elastomeric polymers include silicones; natural and synthetic rubber; natural and synthetic latex; polyurethanes; polybutadienes; neoprene; polyamides; polyesters; polyolefins; and diblock, triblock, tetrablock or other multi-block elastomeric copolymers such as olefinic copolymers, including styrene-isoprene-styrene, styrene-butadiene-styrene, styrene-ethylene/butylenestyrene, or styrene-ethylene/propylene-styrene; polyether block amides.

Suitable materials for the devices disclosed herein may be uncolored and/or substantially transparent or translucent, i.e., clear or substantially clear. Alternatively, the devices disclosed herein may be colored. For example, the devices disclosed herein may be colored to match a color of the frame of the glasses on which they may be installed.

As discussed above, in certain embodiments the material of the opening (12, 22, 32, 42, 62) may be thicker than the remainder of the polymeric body, or at least the portion of the polymeric body configured to fit over the nose pad of the eyeglasses. Moreover, the material extending from the opening toward the opposite end of the device (e.g., end 26 opposite the opening 22 on device 20) may be thicker, or may be formed as a gradient of thickness, such as thickest at the rim and becoming progressively thinner toward the middle of the polymeric body, or the region designed to cover the nose pad. Such a design may allow the regions surrounding the pad support arm to have a size and shape substantially the same in the installed and uninstalled states and may further allow the opening to be configured to rest snugly against the rim of the eyeglasses. That is, the opening may have a shape specifically designed to conform to a shape of the rim of the glasses and the thicker region of the device adjacent the opening may aid in pushing the opening against the frame.

In embodiments of the device (10, 20, 30, 40, 50), portions or all of the polymeric body may be formed of a pliable or non-pliable polymeric material that is non-stretchable. Exemplary materials include polyvinyl chloride and polycarbonate.

Moreover, portions or all of the “polymeric” body may be formed of stretchable or non-stretchable polymeric material that is mixed with additional non-polymeric materials. In such configurations, the “polymeric material” could be any of those listed hereinabove and/or may be a binder useful to bind or consolidate the additional non-polymeric materials. The additional non-polymeric materials may be included to solidify (i.e., reduce stretchiness of regions), color, or add friction to improve contact with the wearer's nose region (reduce the likelihood that the glasses, with the device installed thereon, will slip off the wearer's nose).

Accordingly, while particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application including the appended claims is therefore intended to cover all such changes and modifications that are within the scope of this application.

What is claimed is:

1. A protective device for nose pads and pad support arms on eyeglasses, the device comprising:
a polymeric body having an inner cavity and an opening,
wherein the opening is configured to rest against a rim of the eyeglasses when the device is installed over the nose pad and pad support arm, and
wherein the polymeric body is configured to accept the nose pad and pad support arm therein and fit snugly about at least the nose pad.

2. The device of claim 1, wherein the polymeric body and the opening comprise a stretchable material providing the device with at least two shapes, including,
(i) an uninstalled shape in which the device is separated from the nose pad and pad support arm, wherein the opening has a first overall dimension, and the polymeric body is unstretched, and
(ii) an installed shape in which the device is positioned around the nose pad and pad support arm so that the polymeric body is stretched thereabout to conform to a shape of the nose pad, and the opening has a second overall dimension substantially the same as the first overall dimension.

3. The device of claim 1, wherein the opening comprises a thickened region of the polymeric body.

4. The device of claim 3, wherein the polymeric body includes a second opening opposite the opening so that the device is configured as a sleeve, wherein when the device is positioned around the nose pad and pad support arm, the second opening is stretched around at least a portion of the nose pad.

5. The device of claim 1, wherein the polymeric body further comprises a ridge on an inner surface thereof, wherein the ridge is configured to interact with the pad support arm to secure the device thereon.

6. The device of claim 1, wherein the polymeric body comprises a thickened region on an inner surface thereof that is distal from the opening, wherein the thickened region is configured to interact with the pad support arm to secure the device thereon.

7. The device of claim 6, wherein the thickened region is designed and configured as a nose pad and includes a protrusion configured to provide attachment of the thickened region to the pad support arm.

8. The device of claim 1, wherein the polymeric body includes a longitudinal opening and a hinge region opposite the longitudinal opening such that the device has an open configuration wherein respective edges of the polymeric body along the longitudinal opening are not in contact with each other and a closed configuration wherein the respective edges of the polymeric body along the longitudinal opening are in contact with each other.

9. The device of claim 8, wherein the respective edges of the polymeric body along the longitudinal opening include closure elements.

10. The device of claim 8, wherein the polymeric body comprises a stretchable material providing the device with at least two shapes, including,
(i) an uninstalled shape in which the device is separated from the nose pad and nose pad support arm, wherein the polymeric body is unstretched in either the open or closed configuration, and
(ii) an installed shape in which the device is positioned around the nose pad and nose pad support arm and in the closed configuration such that the polymeric body is stretched around and conforms to a shape of the nose pad.

11. The device of claim 1, wherein the polymeric material comprises an elastomer.

12. A protective device for nose pad support arms on eyeglasses, the device comprising:
a polymeric body having an inner cavity with first and second openings,
wherein the inner cavity comprises a thickened region shaped as a nose pad and including a protrusion configured for attachment to the nose pad support arm of the eyeglasses,
wherein the first opening is distal from the thickened region and is configured to rest against a rim of the eyeglasses when the device is installed over the nose pad support arm,
wherein the second opening is adjacent an outer edge of the thickened region and, when the device is installed over the nose pad support arm, the second opening is configured to provide access to the nose pad support arm and allow connection of the protrusion thereto.

13. The device of claim 12, wherein the device is formed of a pliable material and has at least three configurations comprising
(i) an uninstalled configuration in which the device is separated from the nose pad support arm, wherein the first opening has a first overall dimension, and the polymeric body and second opening are unstretched,
(ii) an installed configuration in which the device is attached to the eyeglasses via connection with the pad support arm, wherein the polymeric body is unstretched and the first opening has a second overall dimension substantially the same as the first overall dimension, and
(iii) an intermediate configuration during attachment of the device to the nose pad support arm of the eyeglasses, wherein the second opening is stretched to allow access to the nose pad support arm for attachment of the device thereto.

14. The device of claim 12, wherein the polymeric material comprises an elastomer.

15. A protective device for nose pads and pad support arms on eyeglasses, the device comprising a polymeric body having:
an inner cavity, wherein the polymeric body is configured to accept the nose pad and pad support arm therein and fit snugly around at least the nose pad; and
an opening having a reinforced rim, wherein the opening is configured to rest against a rim of the eyeglasses when the device is installed over the nose pad and pad support arm,
wherein the polymeric body and the opening comprise a pliable material providing the device with at least two shapes, including,
(i) an uninstalled shape in which the device is separated from the nose pad and pad support arm, wherein the opening has a first overall dimension, and the polymeric body is unstretched, and
(ii) an installed shape in which the device is positioned around the nose pad and pad support arm so that the polymeric body is stretched thereabout to conform to a shape of the nose pad, and the opening has a second overall dimension substantially the same as the first overall dimension.

16. The device of claim 15, wherein the polymeric body includes a longitudinal opening and a hinge region opposite the longitudinal opening, such that the device has an open configuration wherein respective edges of the polymeric body along the longitudinal opening are not in contact with each other and a closed configuration wherein the respective edges of the polymeric body along the longitudinal opening are in contact with each other.

17. The device of claim 15, wherein the polymeric material comprises an elastomer.
